(19) United States
(12) Patent Application Publication
(10) Pub. No.: US 2023/0277965 A1
(43) Pub. Date: Sep. 7, 2023

(54) Fluid Filter and Spill Kit Extreme Odor and Toxin Eliminator, Composition and Process

(71) Applicant: Standard Hydrogen Company, Inc., Doylestown, PA (US)

(72) Inventors: Mariavicenta Wasas, Aurora, OH (US); James WASAS, Aurora, OH (US)

(21) Appl. No.: 18/113,288

(22) Filed: Feb. 23, 2023

Related U.S. Application Data
(60) Provisional application No. 63/316,491, filed on Mar. 4, 2022.
(60) Provisional application No. 63/317,833, filed on Mar. 8, 2022.
(60) Provisional application No. 63/318,473, filed on Mar. 10, 2022.

(51) Int. Cl. B01D 39/06; B01D 27/02; B01D 27/08

(52) U.S. Cl. CPC B01D 39/06; B01D 27/02; B01D 27/08; B01D 2201/08; B01D 2239/045

(57) ABSTRACT

A fluid filter, filtering medium composition, and associated process for removing compounds containing sulfur or other undesirable contaminants from fluids along with unpleasant tastes and odors.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a filter composition and associated method for eliminating cyanide toxins and odors caused by sulfur compounds, and other contaminants from well water and other fluids. Hydrogen sulfide (H₂S), sulfur containing hydrocarbons known as mercaptans or thiols, and sulfur containing compounds such as carbonyl sulfide, carbon disulfide, and so on, are a common cause of the foul odor of fluids, and bad flavor of water, plus toxic nitrous oxides are removed from air.

Thiols also comprise the noxious element of skunk oil and many other animal odors, which can thus be neutralized by application of the inventive composition.

### Background of the Invention

Known methods for removing hydrogen sulfide and other sulfur containing contaminants from water consist of treating the liquid with hydrogen peroxide to make the unwanted sulfur compounds insoluble, after which they can be removed. However, this process is cumbersome, and each of these substances can be dangerous and cause irritation in human eyes and mucus membranes. Hydrogen peroxide is also highly unstable.

Reverse osmosis filters, oxidizing filters and granulated activated carbon filters are also sometimes used to remove sulfur-containing liquid contaminants, but none of these filters, alone or in combination, is regarded as particularly effective, and none are certified to be effective by any international certifying authority.

Similarly, people and pets that have been sprayed with skunk oil are generally treated with baths of tomato juice, baking soda, vinegar or similar home remedies. None of these remedies nor any product currently on the market is known to truly eradicate the smell of skunk oil in an acceptable period of time.

Indoor kitty litter, diaper and waste receptacles, and areas where animals are kept, bred, raised or farmed often lack adequate ventilation resulting in intense odors that need inexpensive resolution.

What is needed is a simple, efficient and cost-effective method of removing hydrogen sulfide, organosulfur contaminants, water soluble cyanide compounds, and other undesirable contaminants from well water and other fluids, confined spaces, and skunk or other animal secretions to remove the unpleasant odor associated with such contaminations.

### BRIEF SUMMARY OF THE INVENTION

In a preferred embodiment, A replaceable fluid filter cartridge for placement into a fluid filter housing in a fluid line, such fluid filter comprising a cartridge packed with a filtering medium composition of granular particles ranging in size from about 15 mm to about 0.001 mm and consisting of a homogeneous composition of the oxides of copper and one or more of the oxides of aluminum, antimony, barium, beryllium, bismuth, boron, calcium, cerium, cesium, dysprosium, erbium, europium, gadolinium, gallium, germanium, hafnium, holmium, indium, iron, lanthanum, lithium, lutetium, magnesium, manganese, molybdenum, neodymium, praseodymium, rhenium, samarium, silicon, silver, strontium, titanium, vanadium, ytterbium, yttrium, zinc and zirconium plus trace catalytic quantities of gold, palladium and platinum.

In another preferred embodiment, the fluid filter cartridge as described herein, wherein the filter cartridge has a diameter three or more times larger than the input line diameter.

In another preferred embodiment, the fluid filter cartridge as described herein, wherein the cartridge is three or more times longer than its own diameter.

In another preferred embodiment, the fluid filter cartridge as described herein, wherein the granular particles range in size from about 5 mm to about 0.03 mm.

In another preferred embodiment, the fluid filter cartridge as described herein, wherein the filter medium composition is at least 80% oxides of copper as determined by ICP-MS solution analysis of nitric acid digestions of the medium.

In another preferred embodiment, the fluid filter cartridge as described herein, wherein the filtering medium composition is comprised of at least 90% by total weight oxides of copper.

In another preferred embodiment, the fluid filter cartridge as described herein, wherein the filtering medium composition is comprised of at least 99% by total weight oxides of copper.

In another preferred embodiment, the fluid filter cartridge as described herein, wherein the composition of the filtering medium composition is recyclable or regenerable.

In another preferred embodiment, the fluid filter cartridge as described herein, wherein the filtering medium composition is comprised of 0.1-20% activated carbon by total weight.

In another preferred embodiment, the fluid filter cartridge as described herein, wherein the activated carbon is granular.

In another preferred embodiment, the fluid filter cartridge as described herein, wherein the activated carbon is extruded or otherwise combined with the filtering medium composition to make a block filter.

In another preferred embodiment, the fluid filter cartridge as described herein, wherein the cartridge is packed with at least 5% by total weight of filtering medium composition and 95% or less by total weight of activated carbon or other known filtering media, optionally mixed with inert media.

In another preferred embodiment, a filtering medium composition of granular particles ranging in size from about 15 mm down to about 0.001 mm and consisting of a homogeneous composition of the oxides of copper and one or more of the oxides of aluminum, antimony, barium, beryllium, bismuth, boron, calcium, cerium, cesium, dysprosium, erbium, europium, gadolinium, gallium, germanium, hafnium, holmium, indium, iron, lanthanum, lithium, lutetium, magnesium, manganese, molybdenum, neodymium, praseodymium, rhenium, samarium, silicon, silver, strontium, titanium, vanadium, ytterbium, yttrium, zinc and zirconium, plus trace catalytic quantities of gold, palladium and platinum wherein: oxides of copper comprise at least 80% of the filtering medium, and non-copper oxides and trace metals comprise between 0.001% and 20% of the filtering medium.

In another preferred embodiment, a filtering medium as described herein, wherein: oxides of copper comprise at least 90% of the filtering medium, and non-copper oxides and trace metals comprise between 0.001% and 10% of the filtering medium.

In another preferred embodiment, the filtering medium as described herein, wherein: oxides of copper comprise at least 99% of the filtering medium, and non-copper oxides and trace metals comprise between 0.00001% and 1.0% of the filtering medium.

In another preferred embodiment, the filtering medium as described herein, further comprising: activated carbon comprises between 0.1%-20% of the filtering medium.

In another preferred embodiment, a process for removing hydrogen sulfide, sulfur containing compounds such as thiols or mercaptans, chlorine, nitrous oxides, cyanide, and other contaminants from a fluid stream that lowers the concentration of these contaminants to levels that are within established safe limits by passing the fluid stream through a fluid filter, such filter comprising a filter housing in which is placed a replaceable filter cartridge that is packed with a filtering medium composition of granular particles ranging in size from about 15 mm down to about 0.01 mm and consisting of a homogeneous composition of the oxides of copper and one or more of the oxides of aluminum, antimony, barium, beryllium, bismuth, boron, calcium, cerium, cesium, dysprosium, erbium, europium, gadolinium, gallium, germanium, hafnium, holmium, indium, iron, lanthanum, lithium, lutetium, magnesium, manganese, molybdenum, neodymium, praseodymium, rhenium, samarium, silicon, silver, strontium, titanium, vanadium, ytterbium, yttrium, zinc and zirconium plus trace catalytic quantities of gold, palladium and platinum.

In another preferred embodiment, the process as described herein, wherein the filtering medium is the filtering medium as described herein.

In another preferred embodiment, the process as described herein, wherein the fluid stream flows upward through the filter.

In another preferred embodiment, the process as described herein, wherein the fluid filter is the fluid filter as described herein.

In another preferred embodiment, the process as described herein, wherein the stream is composed of water.

In another preferred embodiment, the process as described herein, wherein the fluid filter is applied to remove odors associated with sulfur containing compounds comprising H₂S, thiols or mercaptans.

In another preferred embodiment, a process of neutralizing skunk oil and other objectional odors, comprising the steps of:
1. mixing the filtering medium composition as described herein, and
2. applying the composition to a fluid or any material soaked with the fluid until the smell of the fluid has been neutralized.

In another preferred embodiment, the process as described herein wherein the fluid is skunk oil or another sulfurous-smelling fluid.

In another preferred embodiment, a porous filter block composed of the filtering medium composition as described herein, bound together with agglomerating agents and in the shape of a filter cartridge to be used within a filter housing to filter the fluid and remove the objectional contaminants from the fluid stream.

### BRIEF DESCRIPTION OF THE DRAWINGS

FIG. 1A is a line drawing evidencing a preferred filter as used in the inventive process.

FIG. 1B is a line drawings of a filter designed for horizontal mounting which incorporates a spring or several springs to force the filtering media together to prevent media bypass.

FIG. 2A is a line drawings of the inventive composition shown as broken grains.

FIG. 2B is a line drawing of the inventive composition shown as agglomerated grains.

### DETAILED DESCRIPTION OF THE INVENTION

An inventive method to purify water or other fluids by removing hydrogen sulfide, organosulfur compounds, and other unwanted impurities such as chlorine and so on from fluid streams to the lowest concentration possible by passing the fluid through a filter housing, wherein such housing is placed a filtering cartridge containing a medium comprising a composition of granular particles ranging in size from about 15 mm down to about 0.01 mm and consisting of a homogeneous composition primarily of oxides of copper, with smaller amounts of one or more of the oxides of aluminum, antimony, barium, beryllium, bismuth, boron, calcium, cerium, cesium, dysprosium, erbium, europium, gadolinium, gallium, germanium, hafnium, holmium, indium, iron, lanthanum, lithium, lutetium, magnesium, manganese, molybdenum, neodymium, praseodymium, rhenium, samarium, silicon, silver, strontium, titanium, vanadium, ytterbium, yttrium, zinc and zirconium plus trace catalytic quantities of gold, palladium and platinum. The distribution of sizes of the particles within the filter housing is dependent on the type and diameter of the housing, the flow rate, the fluid pressure, and the permitted pressure drop passing through the filter. Typical filter cartridges for wells or household usage would contain particles ranging from about 400 to about 3000 microns while a large industrial type filter housing would typically contain particles ranging from about 2 mm up to about 5 mm or more.

For the purposes of this applications and the claims contained herein, unless otherwise specified, all listed percentages are determined by total weight of the disclosed components and composition. It is noted that, for removal of H2S only from non-reductive fluids, oxides of copper can be used without other oxides or catalytic metals. However, the presence of one or more alternative oxides or catalytic metals are useful to improve the removal of H2S, various other sulfur-containing contaminants, and other undesirable impurities from both non-reductive fluids, and reductive fluids and will improve filtration efficiency.

Copper is the principle metallic component of the granular filtering medium found in some filters advertised as suitable for H2S removal. In the reaction of metallic copper with H2S, hydrogen gas is liberated which can cause age hardening of fixtures, be corrosive to plumbing, and is potentially explosive. However, due to the presence of copper metal oxides instead of copper metal, the composition releases H2O instead of H2 and does not generate potentially explosive hydrogen.

The relevant chemical equation for the process employed is:

CuO+H₂S=>CuS+H₂O

If metallic copper is part of the composition of the filtering media, the chemical reaction would be:

Cu+H2S=>CuS+H2 gas

The filtering medium composition is created as a homogenous mixture with a broad range of grain sizes to reduce potential open spaces and, thus, media bypass during the filtering process. Once the medium is created and mixed to ensure uniformity, it is then inserted into the filter cartridge or sold as a bulk fill for large commercial applications.

To create the inventive granular filtering medium, a solution containing the soluble compounds of copper with the other metals in proportions of total weight ranging from 0.0001% up to 20% is contacted with a 20% solution of the hydroxide, or the carbonate, or both, of sodium in water to form a homogeneous precipitate of hydroxides, carbonates, or both, of the metals which are then dried and heated to drive off the unwanted anions. This process produces a mass of homogeneous solid material that is then broken into irregular granules with a jaw crusher followed by sorting the broken sizes with a rotary screening machine comprising a connected series of rotary sieves arranged as a column or other suitable sizing apparatus. In a preferred embodiment, the column comprises two sieves. The very fine particles pass all the way through the column of sieves and are used for the very small diameter filters or are agglomerated, the particles that pass through the upper sieve but not through the bottom sieve are used in the medium diameter sized filters, and the largest particles that do not go through the upper sieve are used for large filters or are recycled back to the crusher for additional size reduction. With this arrangement, a broad but a controlled range of particles are available for packing the filter cartridges or for bulk commercial uses. The result is that little to none of the particles are wasted.

To create the inventive granular filtering medium as random sized roughly spherical grains an agglomerator and suitable binders may also be used to convert the fine powder into particles of suitable size to function as filtering media. This process eliminates the loss of very fine particles that are too small for use in the filter cartridge, and also yields a free flowing media that is easier to fill filter cartridges mechanically.

In a preferred embodiment, the housing of the filter will be cylindrical, rust-resistant, and the filtering medium will be contained within the cartridge to prevent migration of the medium past the filter.

The filter housing can be composed of anything that will resist the pressure of the fluid being filtered, such as stainless steel, other known corrosion resistant alloys, carbon fiber, compositions such as plastic or fiberglass, etc.

The medium within the filter housing can be recycled or regenerated depending on the use of the filter. The useful lifetime of the filter is dependent upon the concentration of the contaminant in the liquid stream being filtered. The filtering medium will typically increase in weight by about 20% due to the sulfur or other impurities it has trapped. For example, a filter housing containing 1,000 grams of a high concentration CuO filtering medium can absorb approximately 400 grams of H₂S and will release approximately 200 grams or H2O for a net gain of approximately 200 grams, which is a 20% gain.

In a preferred embodiment, the housing will have a diameter of three or more times the diameter of the input line to spread and slow the flow through the filtering medium to decrease the pressure drop created by the resistance of the flow through the medium, and have a length of three or more times its own diameter to insure adequate contact between the fluid being filtered and the filtering medium. Also preferably, the filter cartridge will be arranged such that the fluid feed will flow upward within the body of the cartridge in order to prevent packing of the filter medium that would increase the pressure drop within the cartridge. However, the filter will remain effective in the event that the stream enters downward, or from the side of a horizontally mounted filter that incorporates media bypass protection.

In another embodiment, an alternate process for filtering sulfur or other contaminant compounds out of water or other fluids may be employed wherein the described filtering composition medium is placed, in bulk and without a housing or cartridge, into existing filtering tanks, with periodic extraction and replacement once the composition becomes loaded with sulfur and other contaminants. In such an arrangement, screens would be placed at the points of entry and exit for the fluid to keep the medium from moving out of the tank and into the connected pipes. A sufficient amount of medium would need to be used to fully cover the programmed level of the filtered tank, such that fluid cannot rise around the medium without being filtered.

In another embodiment, the filtering media is held between screens or porous fibrous films such as filtering cloth with the fluid stream passing through the media which may be planar, cylindrical, pleated, or of any other configuration which permit the fluid to be purified.

Alternate embodiments of the disclosed sorption filter and granular media may include combinations with one or more supplemental fluid filtering components, including additional filtering component(s) taken from the group comprising mechanical filters, absorption filters, adsorption filters, sequestration filters, ion exchange filters, reverse osmosis filters, and so on.

In a particular embodiment, the inventive filtering medium is either mixed with or packed adjacent to and in series with activated carbon, sometimes also known as activated charcoal, which is proven to reduce unpleasant tastes and odors from drinking water via sorption. This arrangement would provide dual filtration for even greater effectiveness.

In an alternate embodiment, the fluid filtering cartridge is an enriched activated carbon filter with extra sulfur odor elimination power, wherein the cartridge is packed with 95% or less by total weight of activated carbon and/or other known active filtering media, optionally mixed with a certain percentage of inert media such as alumina. In this iteration, only the remaining at least 5% of the media packing the cartridge is the inventive filtering medium composition. Activated carbon is produced in several forms: powdered, granular, polymer coated, extruded, beads and woven carbon cloth. In the context of the present invention, powdered or beaded carbon could be packed into a second cartridge, corresponding to the dimensions of the filtering medium cartridge, wherein the fluid stream is forced through each cartridge in succession. Similarly, one or more layers of woven carbon might be arranged to overlay one of both of the fluid inlet and fluid outlet to the filtering medium cartridge.

Alternatively, granular activated carbon may be used as a component of the granular filtering medium as previously described. Granular activated carbon may be produced in multiple sizes, for example to ensure or prevent passage through a U.S. Standard Mesh Size No. 20, 40 or 50 sieve, so varying sizes may be used in the inventive medium.

In this iteration, the filtering medium would be comprised of 0.5-9% granular activated carbon for supplemental filtering, more preferably 1-5%.

In another embodiment, the inventive filtering medium may be formed into a block-type filter, either alone or mixed with other media such as activated carbon, wherein one or more carbon-based liquids are added to the block and then decomposed to leave a carbon skeleton to bind the inventive filtering medium to the carbon. Alternatively, the inventive medium may be bound to carbon using the process of agglomeration, using Portland or other chemical binders. The carbon-containing medium could also be used in bulk, directly in water tanks, as previously described.

Finally, as it is known that the primary noxious components contained in skunk oil are thiols, thus, the composition used in the inventive filter can also be applied directly to a fluid containing thiols, such as skunk oil, to neutralize the odor of the contamination. Since the composition is granular in nature, the composition may be applied to materials soaked or contaminated with such thiol-containing liquid, such as human or animal hair, clothing or skin. The media used within the filter cartridge can also be used to absorb and eliminate the odor of any other sulfur containing fluid.

### DETAILED DESCRIPTION OF THE FIGURES

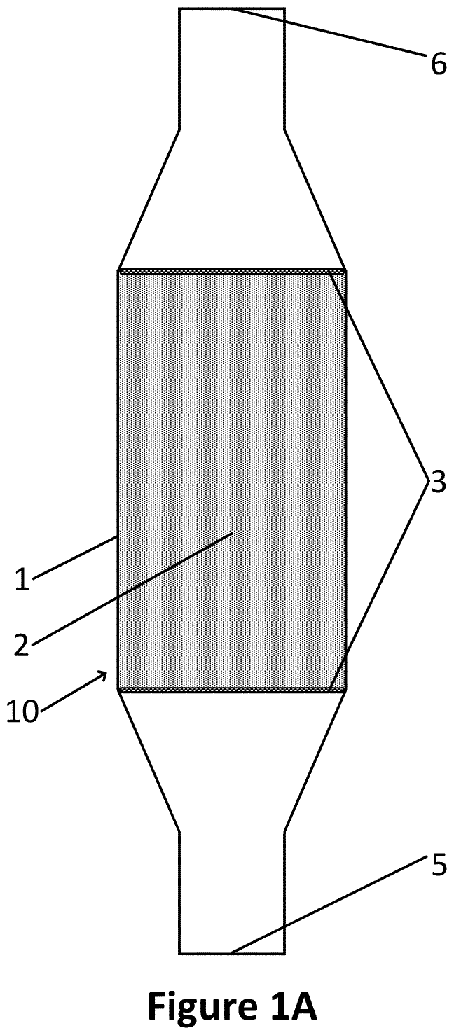

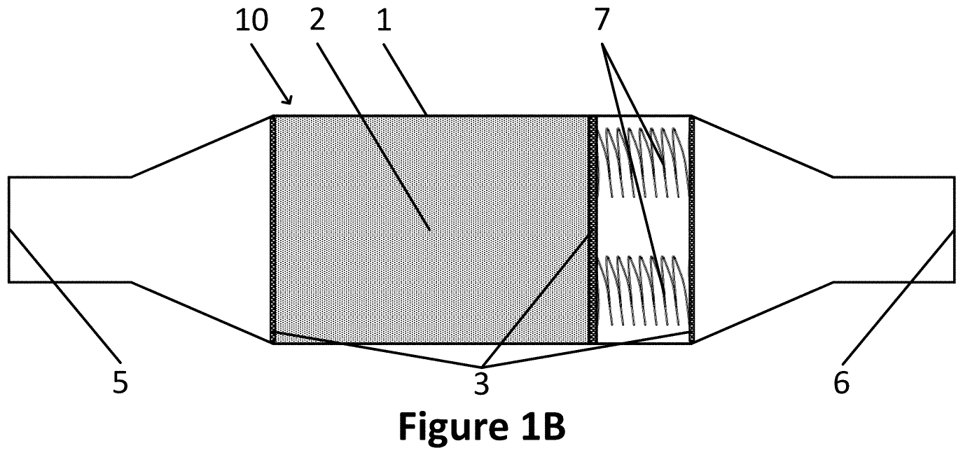

Turning now to the figures, FIG. 1A shows a cross section of a filter 10, comprising filter housing 1, within which are centered two filter discs 3, with filtering medium 2 contained between the two filter discs. The filter is connected to an input line 4 (not shown) and, in a preferred embodiment, flow upward through the filter medium, such that inlet 5 is located on the lower aspect of the filter, while the outlet 6 is located on the upper aspect of the filter. For the purposes herein, the term “filter disc” means any commercially available appropriate fluid filtering disc that will allow a filtered fluid to pass while holding the filter medium in place between the two discs within the housing.

FIG. 1B shows a cross section of a filter 10 intended for horizontal mounting, comprising filter housing 1, within which are centered three filter discs 3, with filtering medium 2 contained between the two filter discs and with a spring or springs 7 between two of the filter discs pushing the media together to prevent media bypass. The type and number of springs required is a function of the diameter of the filter. The filter is connected to an input line 4 (not shown) and such that inlet 5 is located on the input side of the filter, while the outlet 6 is located on the opposite end of the filter.

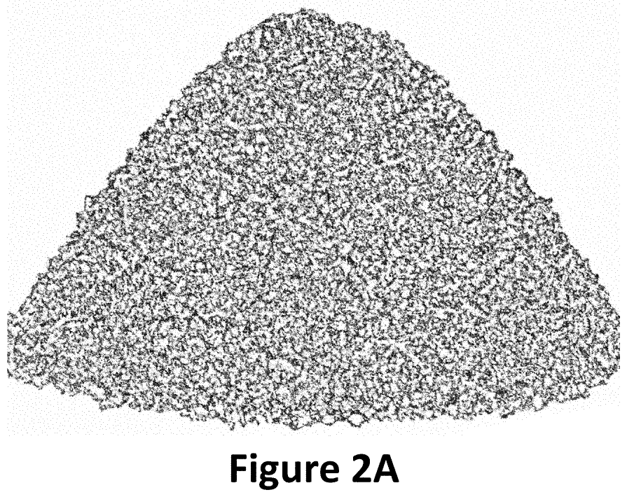

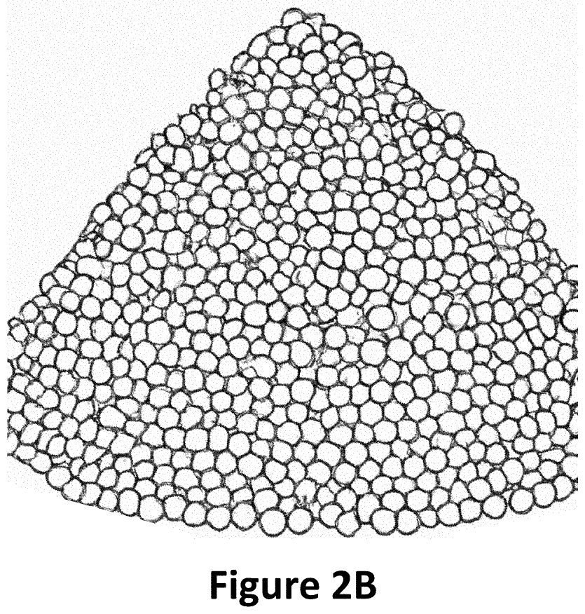

FIG. 2A is a drawing of the inventive filtering composition medium as broken grains. The use of broken grains in a filtering medium provides more resistance to the flow of the fluid through the filter thus adding back pressure to assure thorough contact and sorption of the contaminants.

FIG. 2B is a drawing of the inventive filtering composition medium agglomerated into semi-spherical grains. The use of spherical grains in a filtering medium provides lower back pressure when a viscous fluid is being purified.

### LIST OF REFERENCE NUMBERS

1 Filter housing
2 Filtering medium
3 Filter discs
4 Fluid line (not shown in drawing)
5 Fluid inlet
6 Fluid outlet
7 Spring or springs
10 Fluid filter

The references recited herein are incorporated herein in their entirety, particularly as they relate to teaching the level of ordinary skill in this art and for any disclosure necessary for the more common understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A replaceable fluid filter cartridge for placement into a fluid filter housing in a fluid line, such fluid filter comprising a cartridge packed with a filtering medium composition of granular particles ranging in size from about 15 mm to about 0.001 mm and consisting of a homogeneous composition of the oxides of copper and one or more of the oxides of aluminum, antimony, barium, beryllium, bismuth, boron, calcium, cerium, cesium, dysprosium, erbium, europium, gadolinium, gallium, germanium, hafnium, holmium, indium, iron, lanthanum, lithium, lutetium, magnesium, manganese, molybdenum, neodymium, praseodymium, rhenium, samarium, silicon, silver, strontium, titanium, vanadium, ytterbium, yttrium, zinc and zirconium plus trace catalytic quantities of gold, palladium and platinum.

2. The fluid filter cartridge of claim 1, wherein the filter cartridge has a diameter three or more times larger than the input line diameter.

3. The fluid filter cartridge of claim 1, wherein the cartridge is three or more times longer than its own diameter.

4. The fluid filter cartridge of claim 1, wherein the granular particles range in size from about 3 mm to about 0.03 mm.

5. The fluid filter cartridge of claim 1, wherein the filter medium composition is at least 80% oxides of copper as determined by ICP-MS solution analysis of nitric acid digestions of the medium.

6. The fluid filter cartridge of claim 1, wherein the filtering medium composition is comprised of at least 90% by total weight oxides of copper.

7. The fluid filter cartridge of claim 1, wherein the filtering medium composition is comprised of at least 99% by total weight oxides of copper.

8. The fluid filter cartridge of claim 1, wherein the composition of the filtering medium composition is recyclable or regenerable.

9. The fluid filter cartridge of claim 1, wherein the filtering medium composition is comprised of 0.1-20% activated carbon by total weight.

10. The fluid filter cartridge of claim 9, wherein the activated carbon is granular.

11. The fluid filter cartridge of claim 9, wherein the activated carbon is extruded or otherwise combined with the filtering medium composition to make a block filter.

12. The fluid filter cartridge of claim 1, wherein the cartridge is packed with at least 5% by total weight of filtering medium composition and 95% or less by total weight of activated carbon or other known filtering media, optionally mixed with inert media.

13. A filtering medium composition of granular particles ranging in size from about 15 mm down to about 0.001 mm and consisting of a homogeneous composition of the oxides of copper and one or more of the oxides of aluminum, antimony, barium, beryllium, bismuth, boron, calcium, cerium, cesium, dysprosium, erbium, europium, gadolinium, gallium, germanium, hafnium, holmium, indium, iron, lanthanum, lithium, lutetium, magnesium, manganese, molybdenum, neodymium, praseodymium, rhenium, samarium, silicon, silver, strontium, titanium, vanadium, ytterbium, yttrium, zinc and zirconium, plus trace catalytic quantities of gold, palladium and platinum wherein:
oxides of copper comprise at least 80% of the filtering medium, and
non-copper oxides and trace metals comprise between 0.001% and 20% of the filtering medium.

14. The filtering medium of claim 13, wherein:
oxides of copper comprise at least 90% of the filtering medium, and
non-copper oxides and trace metals comprise between 0.001% and 10% of the filtering medium.

15. The filtering medium of claim 13, wherein:
oxides of copper comprise at least 99% of the filtering medium, and
non-copper oxides and trace metals comprise between 0.00001% and 1.0% of the filtering medium.

16. The filtering medium of claim 13, further comprising:
activated carbon comprises between 0.1%-20% of the filtering medium.

17. A process for removing hydrogen sulfide, sulfur containing compounds such as thiols or mercaptans, chlorine, nitrous oxides, cyanide, and other contaminants from a fluid stream that lowers the concentration of these contaminants to levels that are within established safe limits by passing the fluid stream through a fluid filter, such filter comprising a filter housing in which is placed a replaceable filter cartridge that is packed with a filtering medium composition of granular particles ranging in size from about 15 mm down to about 0.01 mm and consisting of a homogeneous composition of the oxides of copper and one or more of the oxides of aluminum, antimony, barium, beryllium, bismuth, boron, calcium, cerium, cesium, dysprosium, erbium, europium, gadolinium, gallium, germanium, hafnium, holmium, indium, iron, lanthanum, lithium, lutetium, magnesium, manganese, molybdenum, neodymium, praseodymium, rhenium, samarium, silicon, silver, strontium, titanium, vanadium, ytterbium, yttrium, zinc and zirconium plus trace catalytic quantities of gold, palladium and platinum.

18. The process of claim 17, wherein the filtering medium is the filtering medium of claim 13.

19. The process of claim 17, wherein the fluid stream flows upward through the filter.

20. The process of claim 17, wherein the fluid filter is the fluid filter of claim 1.

21. The process of claim 17, wherein the stream is composed of water.

22. The process of claim 17, wherein the fluid filter is applied to remove odors associated with sulfur containing compounds comprising H₂S, thiols or mercaptans.

23. A process of neutralizing the odor of fluids, comprising the steps of:
1. mixing the filtering medium composition of claim 13, and
2. applying the composition to a fluid or any material soaked with the fluid until the smell of the fluid has been neutralized.

24. The process of claim 23, wherein the fluid is skunk oil or another sulfurous-smelling fluid.

25. A porous filter block composed of the filtering medium composition of claim 13 bound together with agglomerating agents and in the shape of a filter cartridge to be used within a filter housing to filter the fluid and remove the objectional contaminants from the fluid stream.
